(19) United States
(12) Patent Application Publication
(10) Pub. No.: US 2021/0347360 A1
(43) Pub. Date: Nov. 11, 2021

(54) AUTOMATED DRIVING ACTIONS FOR DETERMINED DRIVING CONDITIONS

(71) Applicant: Micron Technology, Inc., Boise, ID (US)

(72) Inventors: Elsie de la Garza Villarreal, Nampa, ID (US); Claudia A. Delaney, Garden City, ID (US); Madison E. Wale, Boise, ID (US); Bhumika Chhabra, Boise, ID (US)

(21) Appl. No.: 16/871,178

(22) Filed: May 11, 2020

(51) Int. Cl. B60W 30/14; B60W 40/105; B60W 40/04; B60W 50/14; B60Q 1/06; B60W 60/00

(52) U.S. Cl. CPC B60W 30/146; B60W 40/105; B60W 40/04; B60W 50/14; B60Q 1/06; B60W 2552/15; B60W 2555/60; B60W 2520/10; B60W 2420/42; B60W 2555/20; B60W 60/001

(57) ABSTRACT

A driving control system can apply driving actions such as automatically controlling driving systems (e.g., cruise control, headlights, radio volume, in-vehicle infotainment (IVI) displays, etc.) or providing notifications to the driver or third parties. The driving control system can obtain current driving requirements such as an explicit speed limit, an inferred reduced speed, conditions for heightened driver focus, a headlight requirement, etc. The driving control system can compare the current driving requirements with current driving conditions, such as a current speed, headlight indicators, radio or IVI status, etc. to determine a mismatch. Any such mismatches can be indexed into a mapping of mismatches to driving actions, and if the mismatch is mapped to a driving action, the driving action can be taken.

### TECHNICAL FIELD

The present disclosure is directed to automated driving actions for hybrid vehicle control by a human and a computerized system.

### BACKGROUND

There are over one billion cars on the roads in the world today. In the United States alone, it is estimated that every year drivers spend 70 billion hours driving, drive 2.6 trillion miles, and incur six million traffic accidents. Many of these accidents are due to the failure of drivers to conform to driving requirements such as speed limits, weather restrictions, or headlight requirements. Law enforcement attempts to deter such failures by monitoring for drivers conforming to driving requirements and issuing citations. However, drivers are often distracted or unaware of current driving conditions or ignore such deterrent measures, making them ineffective.

### BRIEF DESCRIPTION OF THE DRAWINGS

FIG. 1 is a block diagram illustrating an overview of devices on which some implementations can operate.

FIG. 2 is a block diagram illustrating an overview of a network environment in which some implementations can operate.

FIG. 3 is a block diagram illustrating components which, in some implementations, can be used in a system employing the disclosed technology.

FIG. 4 is a flow diagram illustrating a process used in some implementations for applying driving actions according to mismatches between current driving requirements and current driving conditions.

FIG. 5A is a conceptual diagram illustrating an example of automating speed controls for a vehicle according to speed requirements provided to the vehicle by a mobile device.

FIG. 5B is a conceptual diagram illustrating an example of emphasizing speed notifications, identified by a camera system, using a projection display.

The techniques introduced here may be better understood by referring to the following Detailed Description in conjunction with the accompanying drawings, in which like reference numerals indicate identical or functionally similar elements.

### DETAILED DESCRIPTION

A driving control system for applying driving actions according to mismatches between current driving requirements and current driving conditions is described. The driving control system can apply driving actions such as automatically controlling driving systems (e.g., cruise control, headlights, radio volume, in-vehicle infotainment (IVI) displays, etc.) or providing notifications to the driver or third parties.

The driving control system can obtain current driving requirements such as an explicit speed limit, an inferred reduced speed, conditions for heightened driver focus, a headlight requirement, windshield wiper requirement, etc. The driving control system can compare the current driving requirements with current driving conditions, such as a current speed, headlight indicators, radio or IVI status, etc., to determine a mismatch. Any such mismatches can be indexed into a mapping of mismatches to driving actions, and if the mismatch is mapped to a driving action, the driving action can be taken.

As a first example, the driving control system can have a mapping specifying that a difference of more than five miles per hour (MPH) of a current vehicle speed over the current speed limit causes a driving action of reducing the vehicle speed to the current speed limit. The driving control system can be programmed with a geographical mapping system that specifies speed limits for particular roadways (e.g., provided by a government database or third-party). Using a current driving condition that defines GPS coordinates, the driving control system can use the geographical mapping system to obtain a current driving requirement specifying the current speed limit. The driving control system can also interface with a vehicle speed monitoring system to get a current driving condition specifying the vehicle's current speed. The driving control system can compare the current vehicle speed with the speed limit and, as specified in the mapping, if the current vehicle speed is more than five MPH over the speed limit, the driving control system can interface with the vehicle's cruise control system to reduce the vehicle's speed to the current speed limit.

As another example, the driving control system can be integrated with a commercial vehicle and can have a mapping specifying that if the vehicle's current speed is both over 35 MPH and is more than 10% over the current speed limit, the driving control system will notify a company recording system of the excessive speed. The driving control system can include a camera and computer vision system configured to determine a current speed limit by capturing images along the roadway and determining which specify speed limits and what those speed limits are. The driving control system can also interface with a vehicle speed monitoring system to get a current vehicle speed. The driving control system can compare the current vehicle speed with the speed limit and, as specified in the mapping, determine if the current speed is over 35 MPH and is at least 10% over the current speed limit. If so, the driving control system can store a log of the excessive speed which it will provide to the company recording system when the vehicle next returns to a company loading dock where the vehicle can access WiFi and post the log.

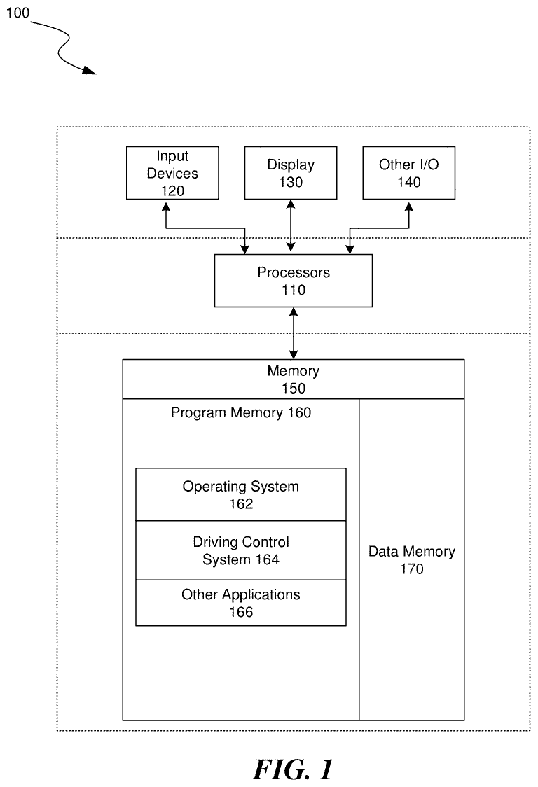

Several implementations are discussed below in more detail in reference to the figures. FIG. 1 is a block diagram illustrating an overview of devices on which some implementations of the disclosed technology can operate. The devices can comprise hardware components of a device 100 that can apply driving actions according to mismatches between current driving requirements and current driving conditions. Device 100 can include one or more input devices 120 that provide input to the Processor(s) 110 (e.g. CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, temperature sensors, moisture sensors, inertial motion (e.g., acceleration) sensors, tilt or level sensors, proximity or sonar sensors, or other input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, driving control system 164, and other application programs 166. Memory 150 can also include data memory 170, e.g., stored driving requirements, driving conditions, or deltas between them; mappings of current driving condition and current driving requirement mismatches to driving actions, data structures for interfacing with driving systems or communication systems for performing driving actions, configuration data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, programmable consumer electronics, network PCs, minicomputers, mainframe computers, distributed computing environments that include any of the above systems or devices, or the like.

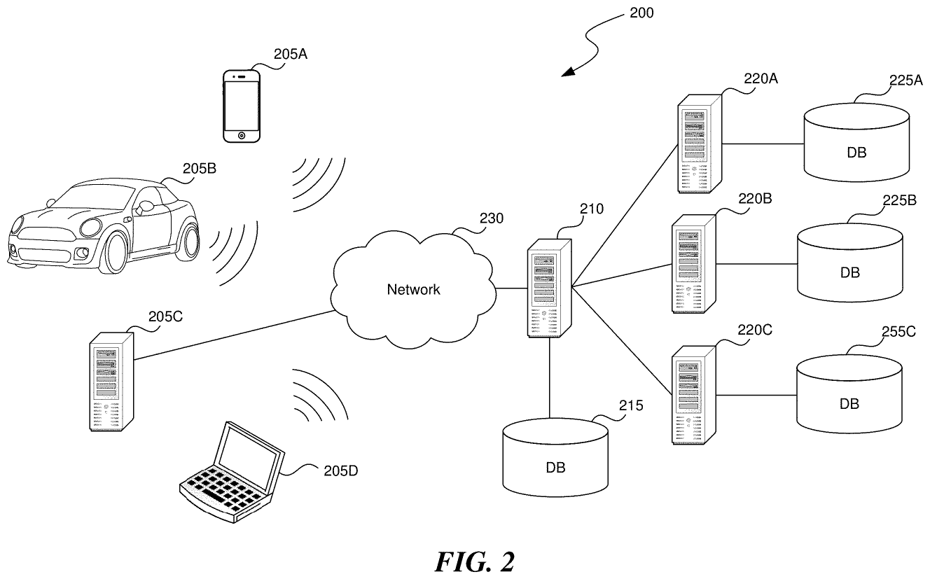

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

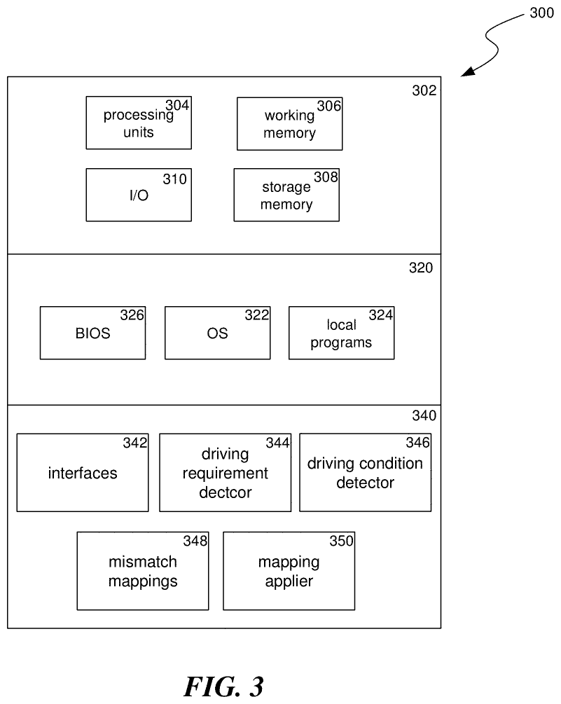

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include driving requirement detector 344, driving condition detector 346, mismatch mappings 348, mapping applier 350, and components which can be used for providing user interfaces, transferring data, and controlling the specialized components, such as interfaces 342. In some implementations, components 300 can be in a computing system that is distributed across multiple computing devices or can be an interface to a server-based application executing one or more of specialized components 340.

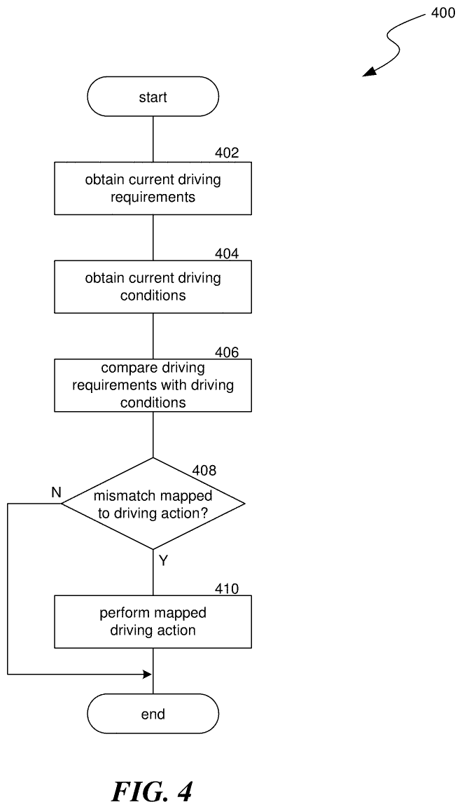

Driving requirement detector 344 can obtain current driving requirements using interfaces to 342 with access to data from vehicle sensors and/or data from a source external to the vehicle, e.g., over a network. Some current driving requirements can include a current speed limit, such as from a geographical mapping system with speed limit data, from capturing and recognizing speed limit signs, or from transponders positioned along the roadway. Additional current driving requirements can be for heightened driver focus, which can be determined based on conditions surrounding the vehicle determined using data from cameras, temperature sensors, moisture sensors, elevation sensors, angle sensors for determining road grade percentages, inertial motion units and/or steering wheel position sensors for determining a turn radius, etc. Yet further current driving requirements can be reduced speed, headlight requirements, or other driving requirements (e.g., traffic rules, safety requirements, company or vehicle owner policies, etc.) Additional details on obtaining current driving requirements are provided below in relation to block 402 of FIG. 4.

Driving condition detector 346 can obtain current driving conditions using interfaces to 342 with access to data from vehicle sensors and/or a vehicle on-board computer. Some current driving conditions can include a current vehicle speed, headlight status, windshield status, radio or IVI settings, current gear selection, current motor revolution frequency, etc. Additional details on obtaining current driving conditions are provided below in relation to block 404 of FIG. 4.

Mismatch mappings 348 can store a set of mappings of A) mismatches (e.g., conditions for comparing the current driving requirements obtained by driving requirement detector 344 with current driving conditions obtained by driving condition detector 346) to B) driving actions that system 300 will perform when the conditions of a mismatch occur. Various of the mismatch mappings 348 can be provided by one or more entities such as a vehicle driver, a vehicle owner, an employer, a government agency, etc. In some implementations, the mapping can map mismatches and/or driving characteristics to driving actions.

Mapping applier 350 can apply the mismatch mappings 348 (or characteristic mappings) to current driving requirements obtained by driving requirement detector 344 and current driving conditions obtained by driving condition detector 346, to determine whether any mismatches (or particular characteristics) are occurring. When mapping applier 350 determines such a mismatch or driving characteristic is occurring, it can cause the one or more driving actions mapped to that mismatch or characteristic to occur. For example, when indicated by a particular driving action, mapping applier 350 can interface with a vehicle cruise control system or other acceleration or braking system to control the vehicle speed, interface with an onboard computer of the vehicle to set windshield wiper controls or headlight status, interface with a radio or other IVI system to change a volume or set a brightness level, or interface with the gearing system to select a current driving gear. Additional details on identifying mismatches specified in mapping and taking corresponding driving actions are provided below in relation to blocks 406-410 of FIG. 4.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 4 is a flow diagram illustrating a process 400 used in some implementations for applying driving actions according to mismatches between current driving requirements and current driving conditions. Process 400 can be performed as a vehicle is operated, e.g., as new current driving conditions and/or current driving requirements are pushed to the driving control system or on a periodic basis as the driving control system polls sensors and data sources for current driving conditions and/or current driving requirements. In various implementations, process 400 can be performed by a computing system integrated with a vehicle or by an external computing system, such as a mobile device, that can interface with the vehicle, e.g., over Bluetooth, or through some other wired or wireless connection.

At block 402, process 400 can obtain current driving requirements. The current driving requirements can specify values for the environment in which vehicle operation is occurring. In some implementations, process 400 can obtain current driving requirements (and current driving conditions at block 404) based on the mapping of current driving condition and current driving requirement mismatches (of driving characteristics) to driving actions, used at blocks 406-410. For example, where process 400 affirmatively retrieves current driving requirements and/or current driving conditions, process 400 can attempt to obtain ones that are used in one or more mismatches mapped to driving actions. In other implementations, current driving conditions and/or current driving requirements are pushed to process 400, which passively receives them. In various implementations, the current driving requirements received at block 402 can include one or more of an explicit speed limit, requirements for heightened driver focus, requirements for reduced speed, headlight requirements, or other driving requirements (e.g., traffic rules, safety requirements, company or vehicle owner policies, etc.)

In some implementations, process 400 can obtain an explicit speed limit or daytime headlight requirements from a geographical mapping system with speed limits or headlight requirements specified for particular roadways. This geographical mapping system can be either pre-programmed into the driving control system or can be from an external source such as a linked (e.g., by Bluetooth) mobile device or from a third-party data source (e.g., over a cellular connection to the Internet). Process 400 can then use GPS or other position data to determine the vehicle's current location on the map and the corresponding speed limit and/or headlight requirements. In other implementations, process 400 can obtain an explicit speed limit or headlight requirement by reading roadway signs with cameras affixed to the vehicle that are processed using a computer vision system (e.g., a system employing a machine learning model, such as a deep neural network, to analyze images to identify headlight requirement signs and/or speed limit signs and which speed limit those signs require). These implementations allow updates for unusual conditions such as temporary speed limits set for construction zones or in extreme weather conditions which may not be represented in a geographical mapping system. In yet other implementations, roadway or roadway signs can be outfitted with transponders allowing direct and reliable communication of speed limits to driving control systems. In some implementations, process 400 can also determine headlight requirements based on a sensor gauging ambient lighting. In some implementations, combinations of these systems can be used, e.g., by using a geographical mapping system to obtain initial speed or headlight requirements, but updating these if a camera captures an image of a sign or weather indicating the speed requirement should be modified.

Where process 400 obtains current driving requirements for heightened driver focus and/or for reduced speed, these requirements can be determined from analyzing conditions surrounding the vehicle (e.g., from cameras, temperature sensors, moisture sensors, elevation sensors, angle sensors for determining road grade percentages, inertial motion units and/or steering wheel position sensors for determining a turn radius, etc.) and/or based on data from external sources such as third parties (e.g., weather forecast systems, governmental agencies that provide roadway or traffic conditions, information from surrounding vehicles either directly or aggregated through a third party, etc.). For example, cameras integrated with a vehicle can capture images, which a computer vision system can be trained to analyze to recognize traffic, weather, turns, road signs, etc. In some implementations, various such inputs can be mapped to situations where heightened driver focus is required and/or reduced speeds are required. In other implementations, such inputs can be provided to a machine learning model trained to identify situations where heightened driver focus is required and/or reduced speeds are required. For example, a machine learning model can be trained with training data items where conditions resulted in an accident corresponding to heightened driver focus or reduced speed requirement conditions.

At block 404, process 400 can obtain current driving conditions. The current driving conditions are conditions over which the driving control system has some control or for which the driving control system can provide a notification, which can allow a driver to adjust driving controls or provide a third party with information on the driving conditions. For example, the current driving conditions can include values such as vehicle speed, whether headlights are active, whether a radio or other sound system is on and its settings (e.g., volume, brightness, channel or station, etc.), whether another IVI system is active and its settings, whether windshield wipers are active, current gear selection, current engine revolutions per minute (RPM), etc. In some cases, process 400 can obtain values for various of the current driving conditions through integrations with the vehicle. For example, the vehicle can provide the current speed directly to the driving control system (e.g., using a sensor system based on tire size and axel rotations). As another example, an onboard computer system on the vehicle can provide values for whether headlights are active, whether a radio or IVI system is on and its settings, whether windshield wipers are active, a current gear selection, current engine revolutions per minute (RPM), etc. In other cases, process 400 can obtain values for various of the current driving conditions through external systems. For example, vehicle speed can be determined based on measured difference between GPS coordinates over a time period, from accelerometer measurements from a known initial (e.g., zero) speed, or based on captured images measuring a change in object position in the images over a time period. As another example, radio or IVI status and settings can be determined based on a microphone or camera of a mobile device within the vehicle.

At block 406, process 400 can compare the current driving requirements from block 402 with the current driving conditions from block 404. In some implementations, process 400 can accomplish this by comparing current driving requirements to current driving conditions of the same type (e.g. speed) to determine a delta for that type. In other implementations, process 400 can accomplish this by iterating through a set of mappings (specifying mismatches between current driving requirement and current driving condition to driving actions) to determine if any of the mapping mismatches (or other driving characteristics) is occurring. In various implementations, some or all of the mapping entries can be set by a vehicle operator, a vehicle owner, an employer, a government agency, etc.

The mapping can include various mismatch conditions such as a current driving condition speed to a current driving requirement speed (explicitly set or implied from reduced speed requirements), a current driving condition headlight setting to a current driving requirement headlight requirement, a current driving condition radio or IVI status to a current driving requirement heightened focus requirement, a current driving condition gear selection and/or motor RPM to a current driving requirement road grade condition, a current driving condition windshield wiper setting to a current driving requirement weather condition, etc. While referred to herein as “mismatches,” the mapping can have various types of comparisons that use various comparator operators, such as < (less than), > (greater than), <= (less than or equal to), >= (greater than or equal to), != (not equal to), or other standard comparison operators. In some implementations, the mapping can specify a transformation or constants to apply to a current driving requirement or current driving condition to determine a mismatch. As examples, a comparison can be between a current speed and 10% over the current speed limit, the current speed plus a constant value, the current speed can be compared to a constant, or other transformations or constant conditions. In some implementations, the mapping can specify combinations of current driving condition and current driving requirement comparisons. For example, a mapping can specify that a mismatch occurs where [the current speed is more than 7% over the current speed limit AND the current speed is at least 35 MPH] OR [the current speed is more than 5% over the current speed limit AND the current turn angle is greater than 25 degrees]. Various combination operators can be used in such combinations, such as AND (where each condition must be met), OR (where either condition must be met), XOR (where exactly one of the conditions must be met), NOT (where a condition must not be met), or other standard combination operators. The symbols and terms described for the above operators are only examples, and other equivalent operator symbols and terms can be used.

At block 408, process 400 can determine whether any determined mismatches are mapped to driving actions. In some implementations, this can include determining whether any deltas for particular types of comparisons of current driving requirements with current driving conditions from block 406 are mapped to one or more driving actions. In other implementations, this can include identifying one or more driving actions mapped, in the mapping specifying mismatch conditions, to any mismatches determined at block 406. If any such driving actions are identified, process 400 can continue to block 410. If no such driving actions are identified, process 400 can skip block 410 and end.

At block 410, process 400 can perform the driving action(s) identified at block 408. In various implementations, driving actions can include one or more of changing a vehicle's speed, modifying a driving system setting (e.g., headlight activation; radio or other IVI deactivation, volume, or brightness control; windshield wiper activation; windshield defroster activation; etc.), changing a current gear selection, providing a notification to a vehicle driver (e.g., via dashboard indicator, heads-up display (HUD) or other projection system, via a paired mobile device, through an audio notification, etc.), providing a notification to another system (e.g., email, text, or other contact to a specified account, entering a log or database item, providing a driving report for a driver of the vehicle, activating a URL or messaging a particular address, or through another communication system), etc. In some implementations where the driving actions include changes other than a notification, options can be provided for the driver to override the driving action. For example, if the driving action includes a change in speed, a change in headlight setting, etc., process 400 can provide a notification that the change is about to occur and the driver can override, e.g., with a voice command, by pressing a particular button, etc.

In some implementations, controlling the vehicle's speed can include interfacing with the vehicle's cruise control system or directly controlling an acceleration system. In some implementations, an automated speed or other driving system change can be accompanied by a notification to the driver of the automated change. For example, a voice message can be played through a vehicle audio system, an alert can sound, a dashboard notification can be illuminated, a HUD or other projection display can be activated, etc. In some implementations, the notification can be dependent on a severity of the mismatch or based on a type of mismatch. For example, depending on different thresholds (e.g., 5 MPH over or under the speed limit, 10 MPH over or under the speed limit, and 15 MPH over or under the speed limit) different notifications or notification settings can be provided (e.g., green, yellow, or red notifications; whether the notification is solid or flashing, setting notification volume, whether notification is provided via the dashboard vs. a HUD, etc.) In some implementations, an initial notification can be provided to the driver, e.g., indicating the current vehicle speed is above or below the limit or an amount of difference between the current vehicle speed and the limit and the driver can be given a threshold amount of time (e.g., 10 seconds, 30 seconds, one minute, five minutes, etc.) to take corrective action. If the driver does not take corrective action (such as changing the speed to the speed limit or to within a threshold amount of the speed limit—e.g. 5 MPH) within the threshold amount of time, the vehicle's speed can be automatically adjusted to be the speed limit or within the threshold amount of the speed limit.

In some implementations, the notification can provide an indication of a difference between a current driving condition and a current driving requirement. For example, the notification can specify that the vehicle is 10 MPH over the current speed limit of 40 MPH. In some implementations, the notification can automatically accentuate factors in the environment that process 400 used to identify a current driving requirement. For example, if process 400 determined a current speed limit based on a speed limit sign detected in an image captured by a camera integrated with the vehicle and process 400 determines there is a mismatch between that speed limit and the vehicle's current speed, it can use a HUD or other projection system to cause the driver of the vehicle to see an accentuating feature (e.g., change color, flashing, highlighting border) on the speed limit sign. As another example, process 400 can determine, based on a current weather report for the area indicating heavy fog, that the vehicle should be driving with low beam headlights, and can determine a mismatch between the vehicle's headlight system (having high beams on) and the low beam current driving requirement. In response, process 400 can provide a voice notification stating that there is heavy fog so low beams should be used. In some implementations, a voice activation system can also be implemented. For example, continuing the previous example, following the voice fog notification, the system can ask the driver if she would like the driving control system to switch to low beam headlights, which the driver can respond to with a vocal yes or no command. Following implementation of the driving actions at block 410, process 400 can end (or can repeat as new current driving conditions and/or current driving requirements are obtained).

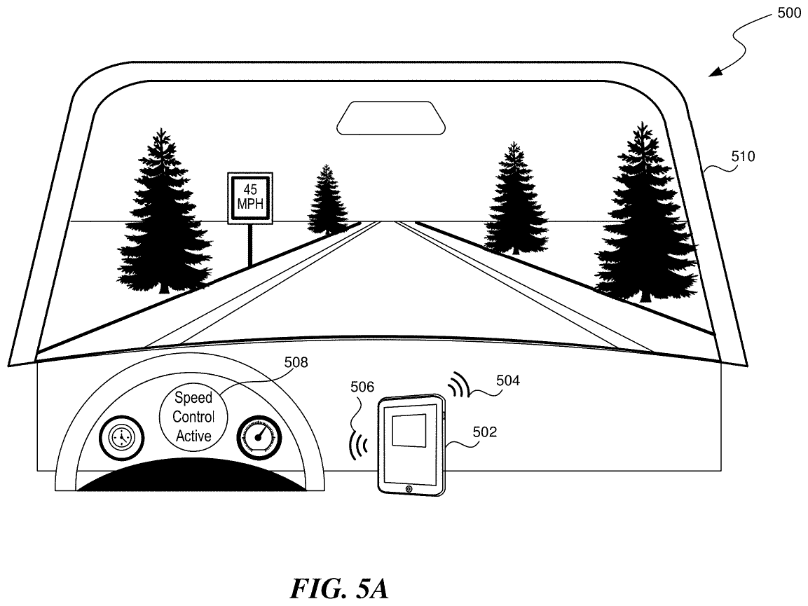

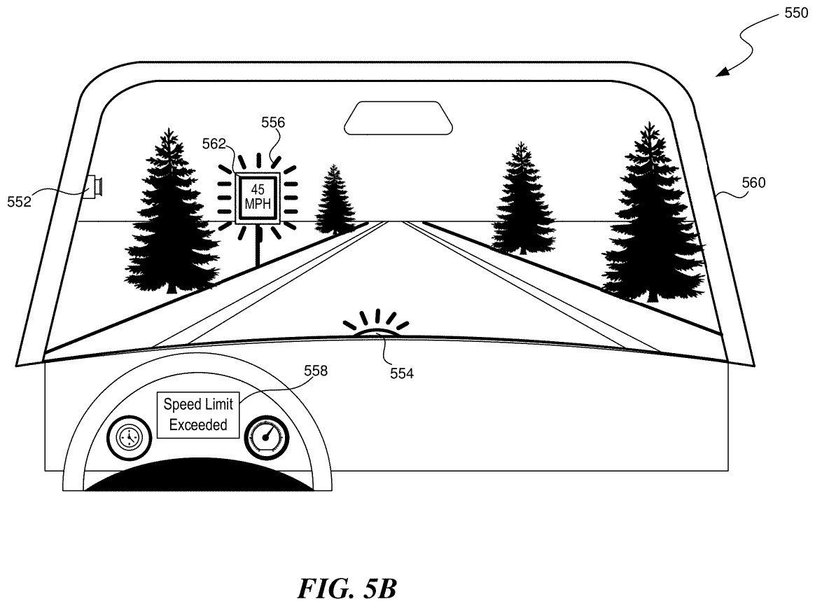

FIG. 5A is a conceptual diagram illustrating an example 500 of automating speed controls for a vehicle according to speed requirements provided to the vehicle by a mobile device. Example 500 includes mobile device 502, which has a cellular connection 504 to the internet and a Bluetooth connection 506. Example 500 also includes vehicle 510, which has a dashboard notification system 508 and can interface with mobile device 502 via the Bluetooth connection 506. In example 500, the mobile device 502 executes a geographical mapping application which receives, via cellular connection 504, a map of a current area with speed limit indicators for various roadways. Using GPS data, the mobile device 502 identifies a current roadway on which the vehicle 510 is traveling and a corresponding speed limit of 45 MPH. Using the Bluetooth connection 506, mobile device 502 also receives a current driving condition indicating the vehicle 510 is traveling at 57 MPH. Using a mapping of current driving condition and current driving requirement mismatches to driving actions programmed into the mobile device 502, mobile device 502 identifies a mismatch that occurs when the vehicle is more than 10 MPH over the current speed limit. In response, the mobile device 502 interfaces, using the Bluetooth connection 506, with a cruise control system of the vehicle 510 to set the current speed of the vehicle 510 to the current driving requirement speed limit of 45 MPH. Also, the dashboard notification system 508 displays a message indicating that speed control has been activated.

FIG. 5B is a conceptual diagram illustrating an example 550 of emphasizing speed notifications, identified by a camera system, using a projection display. Example 550 includes a speed limit sign 562 and a vehicle 560, which has an integrated camera and computer vision system 552, a projection display 554, and a dashboard notification system 558. In example 550, as the vehicle 560 proceeds down a roadway, the camera and computer vision system 552 captures an image of sign 562 and recognizes a current driving requirement speed limit of 45 MPH. The vehicle 560 compares this speed limit to a current driving condition vehicle speed of 60 MPH, specified in a programmed mapping. The vehicle 560 determines these conditions correspond to a mismatch, which specifies that a current driving condition speed of 10% over the current driving requirement speed limit should provide a notification to the driver via the projection display 554 and the dashboard notification system 558. Based on this determination, the vehicle activates the “Speed Limit Exceeded” notification on the dashboard notification system 558 and activates a projection by the projection display 554 which (based on a determined eye position of the driver, monitored by another camera system—not shown) causes the driver to see the sign emphasis 556 as a flashing border around the sign 562.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method comprising:
obtaining one or more current driving requirements specifying at least a speed requirement;
obtaining one or more current driving conditions specifying at least a current vehicle speed;
comparing the speed requirement of the one or more current driving requirements with the current vehicle speed of the one or more current driving conditions and, based on the comparing, identifying at least one characteristic, specified in a mapping of characteristics to driving actions; and
in response to the identifying at least one characteristic, performing one or more actions that correspond, in the mapping, to the at least one characteristic, wherein performing the one or more driving actions includes at least interfacing with a cruise control system of a vehicle to modify the current vehicle speed.

2. The method of claim 1, wherein the speed requirement is determined based on a geographic mapping system that correlates speed limits to roadways.

3. The method of claim 1, wherein the speed requirement is determined based on a computer vision system recognizing a speed limit sign in an image captured by a camera associated with the vehicle.

4. The method of claim 1, wherein the speed requirement is determined based on an identification of a requirement for reduced speed from a specified explicit speed limit, wherein the identification of the requirement for reduced speed is based on one or more of particular traffic conditions, particular weather conditions, particular road construction conditions, a current road grade, a particular turn angle, or any combination thereof.

5. The method of claim 1,
wherein the comparing comprises evaluating at least two expressions with logical operators that each specify how one or more values in the one or more current driving requirements are compared with one or more values in the one or more current driving conditions to satisfy conditions; and
wherein the combination of the at least two expressions are evaluated using a logical combination operator.

6. The method of claim 1, wherein performing the one or more driving actions further includes providing a notification that automated speed control has been activated.

7. The method of claim 6, wherein the notification specifies a difference between a current speed limit and the current vehicle speed.

8. The method of claim 6, wherein the notification is displayed with configurations based on a comparison of a difference between the speed requirement and the current vehicle speed and a threshold that corresponds to notification configurations.

9. The method of claim 1, wherein performing the one or more driving actions further includes providing a notification to a system external to the vehicle indicating the identified at least one characteristic.

10. A non-transitory computer-readable storage medium storing instructions that, when executed by a computing system, cause the computing system to perform operations comprising:
obtaining one or more current driving requirements specifying at least a speed limit;
obtaining one or more current driving conditions specifying at least a current vehicle speed;
comparing the speed limit of the one or more current driving requirements with the current vehicle speed of the one or more current driving conditions and, based on the comparing, identifying at least one characteristic, specified in a mapping of characteristics to driving actions; and
in response to the identifying the at least one characteristic, performing one or more driving actions that correspond, in the mapping, to the at least one characteristic.

11. The computer-readable storage medium of claim 10, wherein performing the one or more driving actions includes at least interfacing with a cruise control system of a vehicle to modify the current vehicle speed.

12. The computer-readable storage medium of claim 10, wherein the speed limit is determined based on a computer vision system recognizing a speed limit sign in an image captured by a camera associated with the vehicle.

13. The computer-readable storage medium of claim 10, wherein the speed limit is determined based on an identification of a requirement for reduced speed, wherein the identification of the requirement for reduced speed is based on one or more of particular weather conditions, particular road construction conditions, a particular turn angle, or any combination thereof.

14. The computer-readable storage medium of claim 10, wherein the comparing comprises evaluating at least two expressions with logical operators that each specify how one or more values in the one or more current driving requirements are compared with one or more values in the one or more current driving conditions to satisfy conditions.

15. The computer-readable storage medium of claim 10, wherein performing the one or more driving actions includes activating a projection system causing display of an accentuating feature on a sign that specifies the speed limit.

16. The computer-readable storage medium of claim 10, wherein performing the one or more driving actions includes connecting to a system external to the vehicle to provide a driving report indicating one or more driving conditions of the vehicle.

17. A computing system for applying automated driving actions, the computing system comprising:
one or more processors; and
one or more memories storing instructions that, when executed by the one or more processors, cause the computing system to perform operations comprising:
obtaining one or more current driving requirements;
obtaining one or more current driving conditions;
comparing the one or more current driving requirements with the one or more current driving conditions and, based on the comparing, determining that at least one mismatch, specified in a mapping of mismatches to driving actions, exists; and
in response to the determining that at least one mismatch exists, performing one or more driving actions that correspond, in the mapping, to the at least one mismatch.

18. The computing system of claim 17, wherein performing the one or more driving actions includes at least interfacing with an acceleration system of a vehicle to modify a current vehicle speed.

19. The computing system of claim 17, wherein the one or more current driving requirements includes a speed requirement that is based on an identification of a requirement for reduced speed based on one or more of road construction conditions or a particular turn angle.

20. The computing system of claim 17, wherein performing the one or more driving actions includes adjusting settings on a vehicle radio or IVI system or adjusting a headlight setting of a vehicle.
